(19) United States
(12) Patent Application Publication
(10) Pub. No.: US 2024/0250837 A1
(43) Pub. Date: Jul. 25, 2024

(54) BYZANTINE FAULT TOLERANT AGREEMENT ON CURRENT TIME

(71) Applicant: VMware, Inc., Palo Alto, CA (US)

(72) Inventors: Teodor Parvanov, Sofia (BG); Hristo Staykov, Sofia (BG); Ittai Abraham, Herzliya (IL)

(21) Appl. No.: 18/157,468

(22) Filed: Jan. 20, 2023

(51) Int. Cl. H04L 9/00; H04L 9/32

(52) U.S. Cl. CPC H04L 9/50; H04L 9/3297

(57) ABSTRACT

Disclosed are examples of systems and methods for determining a blockchain time. One such method comprises receiving, by a non-primary replica node, a pre-prepare message having a timestamp representing a local time of a primary replica node in a blockchain network, verifying, by the non-primary replica node, that a difference between the local time of the primary replica node and a local time of the non-primary replica node does not exceed a hard time limit established for the blockchain network; responding, to the primary replica node, that a time value of the timestamp is within acceptable bounds of the local time of the non-primary replica node; and after consensus is reached amongst the non-replica nodes regarding acceptance of the time value, saving a current blockchain time for the blockchain network based on the timestamp.

### BACKGROUND

It is common for smart contracts stored on a blockchain to express some logic based on time. For example, agreements often have start and end dates, outside of which the agreement no longer holds. Offers have expiries, bills have due dates, and penalties are applied when they are exceeded. Time also helps with activities like auditing, where events on-chain need to be compared to events off-chain, and time can be a tool for applications to reason about reliability. To enable time-based logic in smart contracts, the same timestamp needs to be provided across replica blockchain nodes, as an input for each state-changing smart contract operation. The challenge is for replica nodes to agree on the current time associated with each transition in the context of a byzantine fault tolerant state machine replication protocol, as generally applicable in the context of permissioned blockchains.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows an exemplary blockchain system in accordance with embodiments of the present disclosure.

FIG. 2 provides an exemplary header structure with a time field for a pre-prepare message in accordance with various embodiments of the present disclosure.

FIGS. 3-4 show data flow charts of exemplary processes of the various embodiments of the present disclosure.

FIG. 5 shows components of a blockchain network in accordance with embodiments of the present disclosure.

FIG. 6 illustrates an example of a computing device that can be utilized for systems and methods of the present disclosure.

### DETAILED DESCRIPTION

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

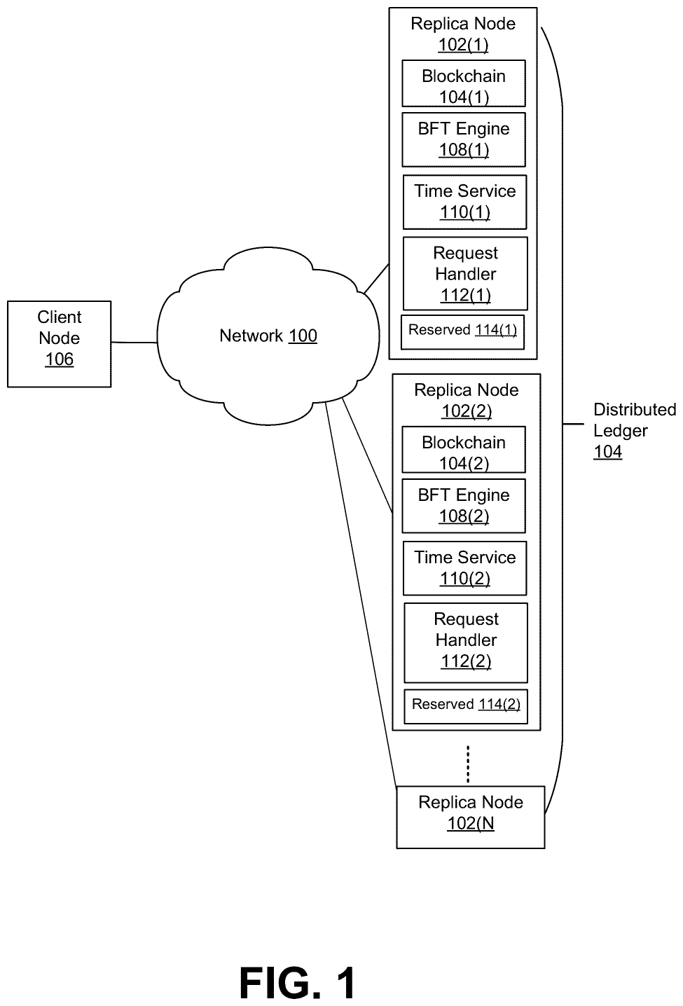

FIG. 1 shows a system in accordance with the present disclosure. The system includes a blockchain network 100 comprising a set of replica nodes 102(1)-(N). Blockchain network 100 implements a shared or distributed ledger referred to as a blockchain 104. In a blockchain network, the “blockchain” is represented in the network by storing a replica of the blockchain in each node comprising the network. In FIG. 1, for example, each blockchain 104 stored in each node 102 (“replica node”) is a replica of the blockchain maintained by blockchain network 100. Replica nodes 102(1)-(N) can be interconnected by a communication network for communication with every other node in the blockchain network. Each replica node 102 executes identical instructions (algorithms) that dictate how to update its shared ledger or blockchain 104 with new transactions and how to determine whether those updates are valid. This configuration may be suitable in a private (permissioned) blockchain where the blockchain network can place restrictions on who is allowed to participate in the network and in what transactions.

In various embodiments, the blockchain network 100 comprises a permissioned distributed trust platform implemented using a Byzantine Fault Tolerant (BFT) State Machine Replication system. Replica nodes 102 use a consensus protocol to communicate and validate subsequent ledger updates. The BFT system allows client nodes 106 to access a single, consistent, and trusted data repository called the state.

A BFT protocol controls communications between the replica nodes 102 that allow them to remain synchronized to maintain the same state on the replica nodes 102. Thus, the BFT protocol can tolerate some replica nodes 102 being slower than others, some replica nodes being disconnected, failing, or even some replica nodes acting maliciously.

In accordance with the BFT protocol, one replica node in each view is designated as the primary replica node (such as node 102(1)). The primary replica node 102(1) communicates with the client node 106, distributes the request received from the client node 106 to the non-primary replica nodes (such as replica nodes 102(2)-(N)), and coordinates the agreement amongst all the replica nodes during consensus. The view determines the primary replica node and is represented by a unique integer number that identifies each view. If there is a need to replace the primary replica node 102(1), a view change process is initiated to designate another replica node as the new primary replica node, and the unique view number changes. A primary replica node is replaced when the node is down or slow to respond (or proven to be byzantine/malicious). Messages exchanged between the replica nodes are only accepted from the current view. When a replica node receives messages from previous views, the node discards them.

The client node 106 usually communicates with the primary replica node 102(1). For example, the client node 106 can send requests to the primary replica node 102(1). The primary replica node then forwards the request to the rest of the replica nodes 102(2)-(N) to be executed, and these replica nodes send the execution results directly back to the client node 106. The primary replica node 102(1) aggregates these results into a batch and initiates a consensus protocol to have all the replica nodes agree on the batch execution order.

If a view change occurs, another replica node has to become the primary replica node, then the client node 106 might need to broadcast the request to all the replica nodes in the network 100. The client node 106 may then wait for the results to discover the new primary replica node. As an example, a view change can occur when the primary replica node is down.

Byzantine Fault Tolerance (BFT) is a feature of the blockchain network 100 to reach agreement or consensus on a same block value even when some of the replica nodes in the blockchain network fail to respond or respond with incorrect information. Accordingly, replica nodes employ a BFT engine 108 to carryout collective decision making which aims to reduce the influence of faulty replica nodes. An exemplary BFT protocol for state machine replication allows client nodes 106 to submit request to blockchain network 100 that orders and execute them. The challenge lies in ensuring that all replicant nodes 102 execute the same sequence of requests, regardless of node faults. The number of tolerated faults is bound to the number of nodes in such a way that it requires 3f+1 replicant nodes 102 to process a client request in the presence of f faults. The challenge is addressed with a three phase message exchange protocol. In a first stage, pre-prepare, the primary replica node 102(1) proposes a sequence number for a pending request using pre-prepare message(s). In a second stage, prepare, all replicant nodes 102(2)-(N) that recognize the sender of the pre-prepare message as the primary replica node acknowledge it to all others using prepare message(s). This is however not enough for agreement, as malicious replica nodes might be sending different messages to different destinations and the set of honest nodes need to preserve ordering even in the event of a view change. Therefore, in the third phase, commit, replica nodes 102(2)-(N) that received 2f acknowledgments will then confirm the outcome to all others. Upon reception of 2f+1 confirmations, the client request can be executed.

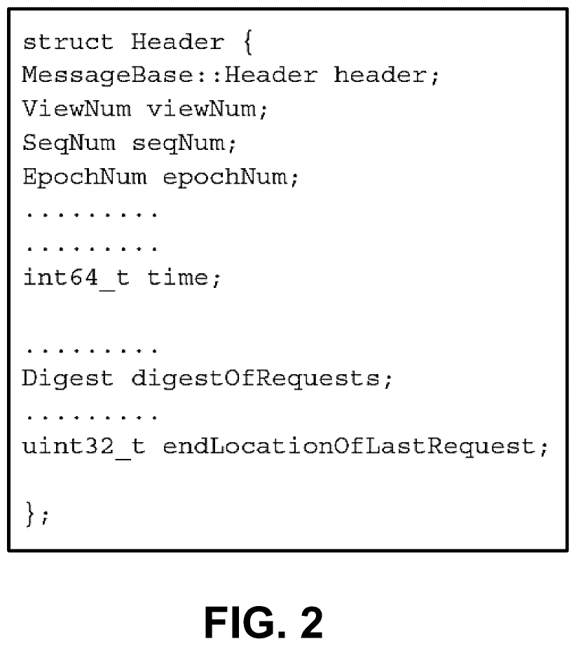

Thus, in accordance with embodiments of the present disclosure, the agreement on a current blockchain time can be seamlessly integrated in the existing BFT replication protocol and consensus mechanism (deployed by the BFT engine 108), leveraging the leading role of the primary replica to ensure time correctness in the blockchain. Accordingly, when a primary replica node 102(1) is in the process of aggregating a logical block of client requests (as a pre-prepare message) to be sent for ordering, the primary replica node 102(1) adds the primary's local time (timestamp) inside a header of this logical block. In various embodiments, the local time of the primary replica node can be obtained from a system clock of the computing device. As time data is present as part of the pre-prepare message header itself, there is no need of a separate client request message. As a non-limiting example, FIG. 2 provides an exemplary header structure with a time field present as “time.”

In various embodiments, the granularity of the time specified in the pre-prepare message (e.g., timestamp) is in microseconds. As such, the non-primary replicas check if the time specified in the message is within time limits or a certain range of the primary replica's local time, e.g., +/− one second from the non-primary replica's local time (as obtained from a system clock of the non-primary replica node). In this case, the consensus proceeds, or otherwise, the message is dropped by the non-primary replica node (whose local time is not within an acceptable range of the primary replica node's local time). A special case may emerge when a pre-prepare message is transferred from a previous view.

Consequently, in various embodiments, the replica nodes do not check the time because the view change mechanism guarantees that those messages were already accepted in the previous view (as identified by the sequence number of the messages), meaning that a pre-prepare message that has to be preserved from a previous view was accepted by at least f+1 replicas (this is guaranteed by the view change algorithm). Hence, the pre-prepare time has been checked by at least 1 honest replica. After a consensus is reached, the agreed upon timestamp is provided to a request handler process 112(1) of the primary replica node, which is an interface between a consensus process of the BFT engine 108(1) and the actual state machine implementation.

By comparison, conventional methods for obtaining a time reference include each node obtaining the real time from its system clock. In order to synchronize the system clocks among the nodes in the blockchain network can involve complicated and expensive techniques. Network time protocol (NTP), precision time protocol (PTP), and/or global positioning system (GPS) deployments can usually keep system clocks within milliseconds of each other. Unfortunately, correct configuration of NTP is notoriously hard, PTP requires special hardware, and even Google's deployment of GPS for their Spanner service often sees skews of hundreds of milliseconds.

Another conventional solution, for example, is to have each node access a central time server for the current time. Unfortunately, this does not solve the problem, because of the asynchrony of those requests. If submitter A reads time t, and submitter B reads time t+1, but B's transaction gets ordered before A's, time will appear to flow backward. In addition, the time at which each validator receives the transaction may also vary widely, especially when catching up after being disconnected. While at first this just sounds annoying, in fact it means that the validators are not deterministic, which violates the requirements of scalable byzantine fault tolerant (SBFT) state machines in that the BFT engine tolerates up to f non-deterministic nodes and due to time skew, there may be more than f non-deterministic nodes. Accordingly, SBFT requires that validator decisions are deterministic. If it is ever possible for two validators to make different decisions because their executions read times on either side of a threshold, execution is no longer deterministic, and SBFT will become stuck. This is only true if more than f nodes are non-deterministic.

Yet another conventional solution is to have a GPS clock publish its time on the blockchain. However, the single GPS clock represents a single point of failure and introduces fragility in the system. If that clock is configured incorrectly or otherwise publishes the wrong time for any reason, the entire system is misled on the current real-world time. If the clock goes offline, time stops for the entire system.

Further, in a prior conventional solution for permissioned systems, every blockchain replica node would send a client request with its local time every second (configurable). After a consensus was reached, all the timestamps were saved in the blockchain, and the blockchain time was determined to be the median of timestamps received from all replicas in the cluster. The main disadvantage of this approach is the redundant load on the cluster and constant growth of storage, even in idle mode.

Now, referring back to operations of systems and methods of the present disclosure, a pre-prepare message whose timestamp is out of limits will be dropped by non-primary replicas 102(2)-(N). However, in various embodiments, two types of time limits can be imposed to allow for recognition of a clock drift at a non-primary replica node 102(2)-(N). The types of time limits include a hard time limit that results in the pre-prepare message being dropped by a receiving non-primary replicant node 102(2)-(N) whose time is out of range and exceeds the hard time limit. The next type of time limits comprises a soft time limit (e.g., soft time limit=½ hard time limit) that results in an error being logged by the receiving non-primary replica node whose time is out of range and exceeds the soft time limit but does not exceed the hard time limit. Thus, in certain embodiments, surpassing the soft time limit does not prevent the non-primary replica node 102(2)-(N) from participating in the consensus process and instead warns an operator or administrator (via system logs) that there is a time deviation that needs correcting between the non-primary replica node 102(2)-(N) and the primary replica node 102(1). Otherwise, if the primary replica node's time is within acceptable bounds of the non-primary replica nodes, the non-primary replica nodes will agree to accept the primary replica node's time as the current time for the blockchain network during consensus. The replica nodes 102(2)-(N) may then pass the agreed-upon time to the BFT engine 108(2)-(N) that can save the time value in a reserved page of memory to be used in interacting with the blockchain network, including smart contract(s). Reserved pages are synchronized across the replicas with BFT guarantees that each replica “sees” the latest agreed upon time stamp.

For example, after consensus is reached, a replica node 102(2)-(N) may provide the timestamp (blockchain time) from the pre-prepare message and the payload (client request(s)) to a request handler process 112(2)-(N). In various embodiments, the request handler's implementation determines whether to use the blockchain time or not. In certain embodiments, for example, this type of time service feature can be turned on or off. As such, the time service feature 110(1)-(N) (that determines the blockchain time) may be turned on only for the cases where it is needed, in various embodiments.

A functional benefit with systems and methods of the present disclosure is that they avoid a constant generation of blocks for storing time service data by utilizing consensus capabilities to decide on the correct time. In accordance with embodiments of the present disclosure, the timestamps of consecutive request executions are strictly monotonic but there are two situations when the monotonicity may be broken: (1) Due to a slight clock drift, the primary replica node sends a pre-prepare request with a timestamp that is behind the previous one but within the time bounds; and (2) After a view change, the new primary replica node's clock is slightly behind the clock of the previous primary replica node.

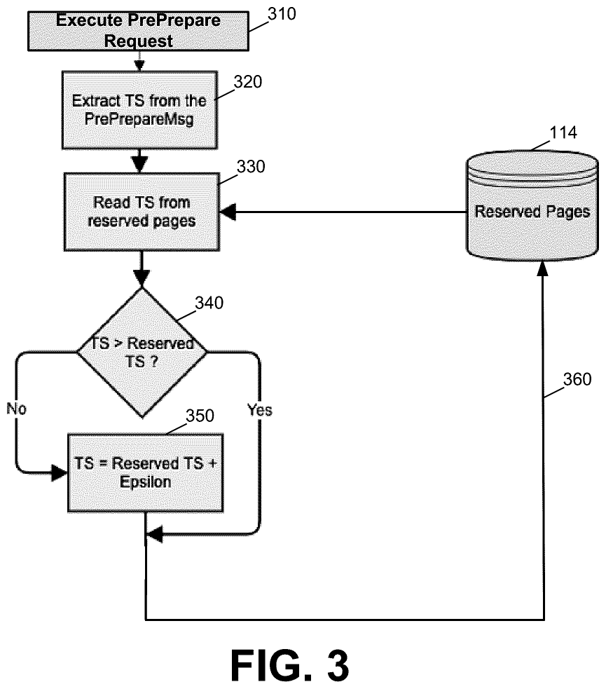

In order to solve the above, replica nodes 102(2)-(N) can save the last agreed-upon blockchain time (timestamp) in the reserved page(s) of memory 114(2)-(N) of the replica nodes, as demonstrated in FIG. 3. Here, the non-primary replica node 102(2) executes (310) a pre-prepare message request from the primary replica node 102(1) and extracts (320) the timestamp (TS) from the pre-prepare message and compares (340) the extracted timestamp from the last timestamp that has been saved in reserved memory 114(2) (reserved pages) of the node 102(2) and is read (330) by the replica node 102(2). Thus, if the new agreed-upon blockchain time is less or equal to the one from the reserved pages, the new time is the time from the reserved page increased (350) by a set amount or “epsilon” (e.g., one millisecond). After the pre-prepare request is executed, the new time is saved (360) in the reserved pages (such as with other data values, including the current view (sequence number)).

Another scenario may be that a pre-prepare message may contain several client requests with a single timestamp. However, some request handlers may need the ability to have different time stamps for client requests within a batch. In order to keep the BFT engine 108 as flexible as possible, in addition to the time provided by the consensus, the BFT engine 108 may be configured to provide the position of a single request in a batch, which can be used by the request handler 114 to increase the blockchain time by a certain amount or epsilon depending on the request's position in the batch.

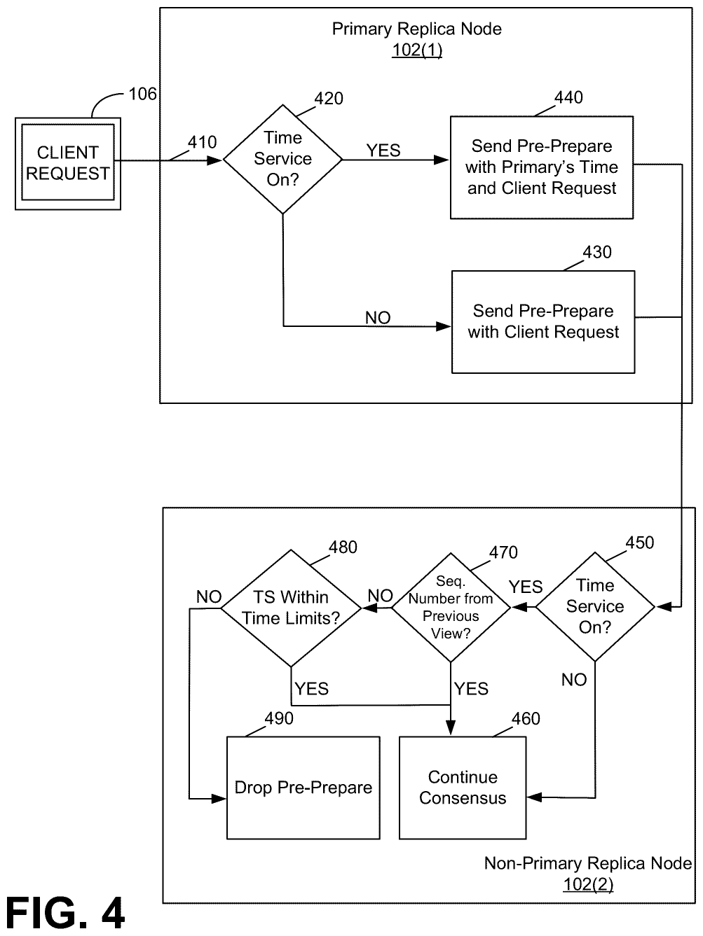

Referring now to FIG. 4, a data flow chart of an exemplary process of the present disclosure is provided. In the figure, processes for a client node 106, a primary replica node 102(1), and a non-primary replica node 102(2) are depicted. Accordingly, a client request is transmitted (410) by a client node 106 to a primary replica node 102(1), where the client request is received by the primary replica node. At the primary replica node, different operations may be performed depending on whether the time service (that determines blockchain time) is on or enabled (420) at the primary replica node. If the time service is not enabled, the primary replica node 102(1) is configured to send (430) a pre-prepare message containing the client request (CR) (and a corresponding sequence number) to the non-primary replica node 102(2). On the other hand, if the time service is enabled, the primary replica node 102(1) is configured to send (440) the pre-prepare message with the client request (CR), sequence number, and a timestamp of the primary's local time. The pre-prepare message is configured to trigger consensus operations at the receiving non-primary replica node 102(2).

At the non-primary replica node 102(2), the pre-prepare message is received from the primary replica node 102(1). However, different operations may be performed depending on whether the time service is on or enabled (450) at the non-primary replica node 102(2). If the time service is not enabled, the non-primary replica node is configured to continue (460) consensus by extracting and processing the client request from the pre-prepare message. On the other hand, if the time service is enabled, the non-primary replica node 102(2) is configured to check (470) if a sequence number associated with the client request is for a previous view. Accordingly, when the non-primary replica node 102(2) receives proposals for consensus (pre-prepare messages) for sequence numbers or IDs from previous views, the node discards the timestamp and continues processing the client request as part of the consensus protocol. Otherwise, when the pre-prepare message is for a sequence number from a current view, the timestamp is checked (480) to determine if the timestamp is within acceptable bounds or ranges of a local time of the non-primary replicant node 102(2). For example, if a difference between the local time of the non-primary replica node 102(2) and the timestamp (corresponding to a local time of the primary replica node 102(1)) does not exceed a hard time limit, the non-primary replica node 102(2) performs consensus operations (460) on the client request contained in the pre-prepare message. On the other hand, if the difference between the local time of the non-primary replica node and the timestamp (corresponding to a local time of the primary replica node) exceeds the hard time limit, the non-primary replica node 102(2) drops (490) the pre-prepare message (such that the non-primary replica node does not perform consensus operations on the client request contained in the pre-prepare message). Additionally, if detected by other non-primary replicas, this will eventually result in a view change.

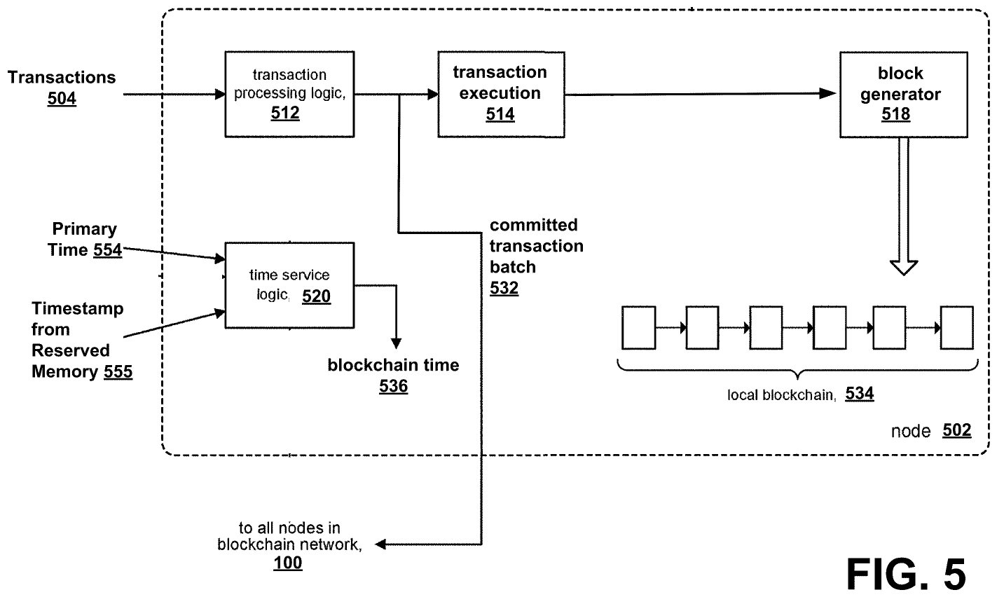

Referring now to FIG. 5, additional detail of nodes 102(1)-(N) in blockchain network 100 are discussed. Node 502 in FIG. 5 is representative of each node 102 in FIG. 1 and shows details in accordance with some embodiments. In some embodiments, for example, node 502 can include transaction processing logic 512 to process received transactions 504. The transaction processing logic can verify transactions before they are added to blockchain 534. In some embodiments, for example, a client that submits transactions (e.g., 504) may digitally sign their transactions, e.g., using public-private key encryption. Transaction processing logic can verify the digital signature of a received transaction before allowing further processing on the transaction. Transaction processing logic 512 can pass transactions to transaction execution logic 514 to initiate generating a block. In some embodiments, for example, the trigger for generating a block can be the accumulation of some number of transactions. It will be appreciated that other criteria can be used to trigger generating a block. Transaction execution logic 514 can broadcast (publish) a committed transaction batch 532 to all other nodes in the blockchain network 100, such that transaction batches are executed by each replica to create the local block (via block generator 518). Transactions can comprise executable program code referred to as “smart contracts.” The transaction execution logic can instantiate a virtual machine to execute smart contracts. In some embodiments, block generator 518 can execute transactions at the time that the block is added to blockchain 534.

Node 502 can include time service logic 520 to provide blockchain time 536 that can then be used by other components in the node as a time reference. A time reference is used in many ways in the blockchain. In some embodiments, for example, when a transaction is added to a new block on the chain, the time that the block was added is stamped on it, as the “record time.” When a client application submits a transaction to the blockchain, it may be labelled with a “ledger effective time” to specify the earliest time the transaction can be allowed onto the blockchain and/or a “max record time” to specify the latest time the transaction can be allowed onto the blockchain. The time reference can be used to record the time when a block is mined (Bitcoin, Ethereum). A time reference may be used during the execution of smart contracts, for instance, to determine start and end dates, offer expiration times, due dates, and so on.

Time service logic 520 can receive a primary replica node's local time value 554 from a timestamp contained in a header of a pre-prepare message and can receive a saved timestamp 555 for a previous view that is maintained in reserved memory. The node 502 is configured to determine the blockchain time 536 from using the primary replica's timestamp, as discussed in relation to FIG. 3.

In accordance with embodiments of the present disclosure, a blockchain replica node can reach consensus among the other nodes in the blockchain network to establish the order in which to add transactions to the blockchain. Accordingly, the blockchain node can obtain a blockchain time from a time service (e.g., time service logic 520) executing on the blockchain replica node. In turn, the blockchain replica node can generate a validated block from the received transactions and add the validated block to the blockchain. In various embodiments, a block can be added to the blockchain by computing a hash value from the contents of the last block in the blockchain using a hash function, such as the SHA-1 hash algorithm. The content of a block includes transaction data and additional data, such as a nonce value so that the computed hash value exhibits a predefined characteristic. The process can be repeated when another new block is added to blockchain.

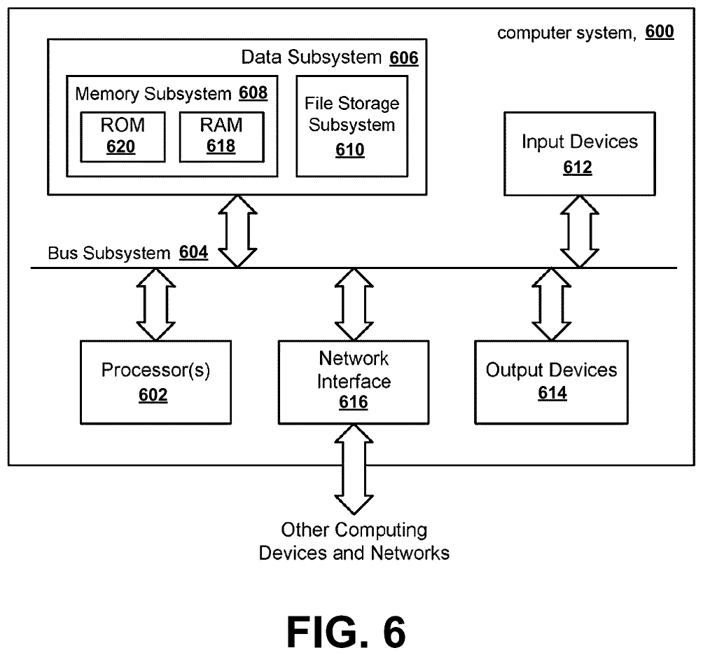

FIG. 6 depicts a simplified block diagram of an example computer system 600 according to certain embodiments. Computer system 600 can be used to implement nodes in the blockchain network described in the present disclosure. As shown in FIG. 6, computer system 600 includes one or more processors 602 that communicate with a number of peripheral devices via a data bus subsystem or interface 604. These peripheral devices include data subsystem 606 (comprising memory subsystem 608 and file storage subsystem 610), user interface input devices 612, user interface output devices 614, and network interface subsystem 616.

Bus subsystem 604 can provide a mechanism that enables the various components and subsystems of computer system 600 to communicate with each other as intended. Although bus subsystem 604 is shown schematically as a single bus, alternative embodiments of the bus subsystem can utilize multiple busses.

Network interface subsystem 616 can serve as an interface for communicating data between computer system 600 and other computer systems or networks; e.g., other nodes in the blockchain network. Embodiments of network interface subsystem 616 can include, e.g., an Ethernet card, a Wi-Fi and/or cellular adapter, digital subscriber line (DSL) units, and/or the like.

User interface input devices 612 can include a keyboard, pointing devices (e.g., mouse, trackball, touchpad, etc.), a touchscreen incorporated into a display, audio input devices (e.g., voice recognition systems, microphones, etc.) and other types of input devices. In general, use of the term “input device” is intended to include all possible types of devices and mechanisms for inputting information into computer system 600.

User interface output devices 614 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 600.

Data subsystem 606 includes memory subsystem 608 and file/disk storage subsystem 610 represent non-transitory computer-readable storage media that can store program code and/or data, which when executed by processor 602, can cause processor 602 to perform operations in accordance with embodiments of the present disclosure.

Memory subsystem 608 includes a number of memories including main random access memory (RAM) 618 for storage of instructions and data during program execution and read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and many other configurations having more or fewer components than system 600 are possible.

These and other variations, modifications, additions, and improvements may fall within the scope of the appended claims(s). As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as magnetic, optical, semiconductor, or other suitable media. Examples of a suitable computer-readable media include, but are not limited to, solid-state drives, magnetic drives, and flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the principles of the disclosure. All modifications and variations are intended to be included herein within the scope of this disclosure.

Therefore, the following is claimed:

1. A non-transitory computer-readable medium comprising machine-readable instructions, wherein the instructions, when executed by at least one processor, cause a computing device to at least:
receive a pre-prepare message having a timestamp representing a local time of a primary replica node in a blockchain network, wherein the pre-prepare message further comprises a client request and a sequence number, wherein the computing device comprises a non-primary replica node in the blockchain network, wherein the client request comprises a transaction to be added to a blockchain stored on the computing device;
verify that a difference between the local time of the primary replica node and a local time of the computing device does not exceed a hard time limit established for the blockchain network;
respond, from the computing device to the primary replica node, that a time value of the timestamp is within acceptable bounds of the local time of the non-primary replica node; and
after consensus is reached amongst the computing device with other non-replica nodes regarding acceptance of the time value, save a current blockchain time for the blockchain network based on the timestamp.

2. The non-transitory computer-readable medium of claim 1, wherein the blockchain network comprises a permissioned blockchain network.

3. The non-transitory computer-readable medium of claim 1, wherein the instructions further cause the computing device to:
check that the difference between the local time of the primary replica node and the local time of the computing device does not exceed a soft time limit established for the blockchain network, wherein the soft time limit is less that the hard time limit; and
log an error warning that a time deviation exists between the non-primary replica node and the primary replica node.

4. The non-transitory computer-readable medium of claim 1, wherein the instructions further cause the computing device to:
check whether a time value included in the timestamp is less than or equal to a prior time value that is saved in reserved memory of the computing device; and
upon determining that the time value is less than or equal to the prior time value, determine the current blockchain time to be the prior time value incremented by a set amount.

5. The non-transitory computer-readable medium of claim 1, wherein the instructions further cause the computing device to determine an ordering consensus with other non-primary replica nodes for an insertion order of transactions into the blockchain network.

6. The non-transitory computer-readable medium of claim 1, wherein the instructions further cause the computing device to:
receive a second pre-prepare message having a second timestamp representing a new local time of the primary replica node in the blockchain network;
verify that a difference between the new local time of the primary replica node and a new local time of the computing device does exceed the hard time limit established for the blockchain network; and
drop the second pre-prepare message.

7. The non-transitory computer-readable medium of claim 1, wherein the instructions further cause the computing device to execute a smart contract on the blockchain using the current blockchain time.

8. A system, comprising:
a computing device comprising at least one processor; and
a memory comprising machine-readable instructions, wherein the instructions, when executed by the at least one processor, cause the computing device to at least:
receive a pre-prepare message having a timestamp representing a local time of a primary replica node in a blockchain network, wherein the pre-prepare message further comprises a client request and a sequence number, wherein the computing device comprises a non-primary replica node in the blockchain network, wherein the client request comprises a transaction to be added to a blockchain stored on the computing device;
verify that a difference between the local time of the primary replica node and a local time of the computing device does not exceed a hard time limit established for the blockchain network;
respond, by the computing device to the primary replica node, that a time value of the timestamp is within acceptable bounds of the local time of the non-primary replica node; and
after consensus is reached amongst the computing device with other non-replica nodes regarding acceptance of the time value, save a current blockchain time for the blockchain network based on the timestamp.

9. The system of claim 8, wherein the blockchain network comprises a permissioned blockchain network.

10. The system of claim 8, wherein the instructions further cause the computing device to:
check that the difference between the local time of the primary replica node and the local time of the computing device does not exceed a soft time limit established for the blockchain network, wherein the soft time limit is less that the hard time limit; and
log an error warning that a time deviation exists between the non-primary replica node and the primary replica node.

11. The system of claim 8, wherein the instructions further cause the computing device to:
check whether a time value included in the timestamp is less than or equal to a prior time value that is saved in reserved memory of the computing device; and
upon determining that the time value is less than or equal to the prior time value, determine the current blockchain time to be the prior time value incremented by a set amount.

12. The system of claim 8, wherein the instructions further cause the computing device to determine an ordering consensus with other non-primary replica nodes for an insertion order of transactions into the blockchain network.

13. The system of claim 8, wherein the instructions further cause the computing device to:
receive a second pre-prepare message having a second timestamp representing a new local time of the primary replica node in the blockchain network;
verify that a difference between the new local time of the primary replica node and a new local time of the computing device does exceed the hard time limit established for the blockchain network; and
drop the second pre-prepare message.

14. The system of claim 8, wherein the instructions further cause the computing device to execute a smart contract on the blockchain using the current blockchain time.

15. A method comprising:
receiving, by a computing device, a pre-prepare message having a timestamp representing a local time of a primary replica node in a blockchain network, wherein the pre-prepare message further comprises a client request and a sequence number, wherein the computing device comprises a non-primary replica node in the blockchain network, wherein the client request comprises a transaction to be added to a blockchain stored on the computing device;
verifying, by the computing device, that a difference between the local time of the primary replica node and a local time of the computing device does not exceed a hard time limit established for the blockchain network;
responding, by the computing device to the primary replica node, that a time value of the timestamp is within acceptable bounds of the local time of the non-primary replica node; and
after consensus is reached amongst the computing device with other non-replica nodes regarding acceptance of the time value, saving a current blockchain time for the blockchain network based on the timestamp.

16. The method of claim 15, further comprising:
checking, by the computing device, that the difference between the local time of the primary replica node and the local time of the computing device does not exceed a soft time limit established for the blockchain network, wherein the soft time limit is less that the hard time limit; and
logging, by the computing device, an error warning that a time deviation exists between the non-primary replica node and the primary replica node.

17. The method of claim 15, further comprising:
checking, by the computing device, whether a time value included in the timestamp is less than or equal to a prior time value that is saved in reserved memory of the computing device; and
upon determining that the time value is less than or equal to the prior time value, determining, by the computing device, the current blockchain time to be the prior time value incremented by a set amount.

18. The method of claim 15, further comprising determining, by the computing device, an ordering consensus with other non-primary replica nodes for an insertion order of transactions into the blockchain network.

19. The method of claim 15, further comprising:
receiving, by the computing device, a second pre-prepare message having a second timestamp representing a new local time of the primary replica node in the blockchain network;
verifying, by the computing device, that a difference between the new local time of the primary replica node and a new local time of the computing device does exceed the hard time limit established for the blockchain network; and
dropping, by the computing device, the second pre-prepare message.

20. The method of claim 15, further comprising executing, by the computing device, a smart contract on the blockchain using the current blockchain time.
